(19) United States
(12) Patent Application Publication
(10) Pub. No.: US 2005/0145401 A1
(43) Pub. Date: Jul. 7, 2005

(54) Pneumatic wrench hammer

(76) Inventor: Hsin-Her Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/751,625

(22) Filed: Jan. 5, 2004

(51) Int. Cl. B25D 15/00

(52) U.S. Cl. 173/93.5; 173/93

(57) ABSTRACT

An improved hammering structure of a pneumatic wrench is comprised of a hammering holder having its one end connected to a pneumatic motor via a threaded hole, and containing two chambers each to accommodate a hammer; a hetero-hole being provided in each hammer to be linked to the transmission shaft; a reinforced rib is provided between two linking ribs at the terminal of the transmission shaft to connect both linking ribs for improving rigidity of both linking ribs and eliminating over concentrated stress; a separation rib being provided in the hammering holder to separate both hammers for avoiding friction between two hammers, thus to upgrade rigidity of the hammering holder and extend its service life.

### BACKGROUND OF THE INVENTION

(a) Field of the Invention

The present invention is related to an improved structure of a pneumatic wrench, and more particularly to hammering linkage of the pneumatic wrench by improving the shape of the linking ribs of the transmission shaft to upgrade anti-torsion moment and eliminate over concentrated stress, and the hammering holder is provided with multiple separation ribs to reduce the tear and wear between two hammers and increase the rigidity of the hammering holder, thus to increase the service life of the pneumatic wrench.

(b) Description of the Prior Art

A pneumatic wrench is a tool essentially applied to tighten or loosen up extra large nuts and screws. Whereas the tightening torque demand is extremely high by the applied screw and nut, the torque produced by the pneumatic wrench is also very high. Therefore the structure of the wrench is also subject to the torque. Referring to FIGS. 1 and 2 of the accompanying drawing, a hammering structure 10 of a pneumatic wrench of the prior art essentially includes a hammering holder 11, a threaded hole 111 provided at one end of the hammering holder 11 is connected to a pneumatic motor, and a through hole provided at another end receives insertion of a transmission shaft. The hammering holder 11 contains two hammers 13, 14 with both pivoted in position by two pins 15, 16. Two hetero-holes 131, 141 respectively provided in both hammers 13, 14 are linked to a respective linking rib 121 from the transmission shaft 12.

While the pneumatic motor is turned on, the hammering holder 11 synchronously drives both hammers 13, 14 to revolve, thereby the transmission shaft 12 linked to the hammering holder 11 also synchronously revolves. The transmission shaft 12 revolves as driven by both hammers 13, 14 placed in different orientations from each other, and also by the synchronously revolving linking rib 121.

However, in practice, the hammering structure of the prior art is found with the following flaws:

1. The transmission shaft being vulnerable to crack up due to the over concentrated stress produced by the linking rib: as illustrated in FIGS. 1 and 3, the linking rib 121 of the transmission shaft for being subject to the revolving force from both hammers 13, 14 creates high torque output that relatively puts the linking rib 121 under comparatively larger load, particularly, a concentration of stress will be developed at a corner A of the linking rib 121, resulting in cracking failure to the transmission shaft.

2. Friction between two hammers: as illustrated in FIG. 2, the pneumatic wrench is operating at high speed revolutions, friction at high speed between those two abutted hammers 13 14 creates heat and wear to damage both hammers 13, 14 while consuming certain portion of the energy for nothing.

3. Stress concentration also developing at the hammering holder due to its comparatively poor rigidity: referring to FIGS. 1 and 4, stress concentration also develops at a corner B inside the hammering hold 11 that transmits the drive force and is vulnerable to the cracking failure due to the absence of any design to distribute the stress, thus to reduce the service life of the hammering holder 11.

4. Hammers and locking pins being subject to stress: whereas both of the hammers 13 14 are respectively pivoted by two locking pins 15, 16 to the hammering holder 11, and both locking pins 15, 16 linked to both hammers 13, 14 at the same time are subject to the force applied by the hammering holder 11, the hammering holder 11 when transmitting the force to drive both hammers 13, 14 to revolve entirely rely upon both locking pins 15, 16 to transmit the force. Accordingly, both locking holes 112, 113 respectively receiving the insertion of both locking pins 15, 16 are subject to the stress created by both locking pins 15, 16. As both of the locking holes 112, 113 have smaller area to withstand the pressure, thus have comparatively poor rigidity, and the length of both locking holes 112, 113 must be extended to such extent practically same as the length of hammering holder 11. Consequently, heavier process is required to drill and shear both locking holes 112, 113, resulting in relatively increase of process cost.

The service life of the hammering structure of the pneumatic wrench of the prior art is therefore significantly discounted due to that failure resulted from over concentrated stress takes place at both of the linking rib of the transmission shaft and the hammering holder, and that the affected power and abnormal wear to both hammers resulted from excessively friction between two hammers.

### SUMMARY OF THE INVENTION

The primary purpose of the present invention is to provide an improved structure of the hammering structure of a pneumatic wrench. To achieve the purpose, the present invention is comprised of a transmission shaft, two hammers and a hammering holder. A front linking rib and a rear linking rib are provided at the terminal of the transmission shaft, and each is connected to a circular reinforcement rib, for both linking ribs to become integrated in one piece. A separation rib is provided in the hammering holder to divide the hammering holder into two chambers to respectively accommodate both hammers. In each chamber, a locking pin and a protruded pin pivoted and linked to respective hammer to form a hammering structure provided with higher rigidity.

The hammering structure provided by the present invention by altering the over concentrated stress by means of providing a circular reinforcement rib between the front and the rear linking ribs; separating two hammers from each other by providing a separation rib inside the hammering holder to avoid waste of power consumption and friction, and further to improve the rigidity of the hammering holder, distribute the stress for avoiding over concentrated stress at the corner; and shortening the length of the locking pin to be partially replaced with a protruded pin in each chamber to be integrated with the hammering holder effectively lower the production cost, upgrade the rigidity and service life of the hammering structure, thus the service life of the pneumatic wrench.

### BRIEF DESCRIPTION OF THE DRAWINGS

FIG. 1 is an exploded view of a hammering structure of a pneumatic wrench of the prior art.

FIG. 2 is a sectional view of an assembly of the pneumatic wrench of the prior art.

FIG. 3 is a layout of a transmission shaft of the prior art.

FIG. 4 is a layout of a hammering holder of the prior art.

FIG. 5 is an exploded view of a preferred embodiment of the present invention.

FIG. 6 is a sectional view of an assembly of the preferred embodiment of the present invention.

FIG. 7 is a sectional view of a hammering holder of the preferred embodiment of the present invention.

FIG. 8 is a sectional view taken from a-a in FIG. 7 of the top of the preferred embodiment of the present invention.

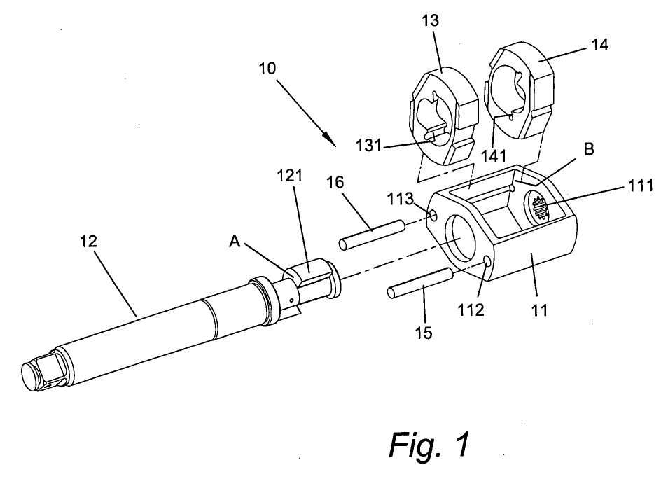

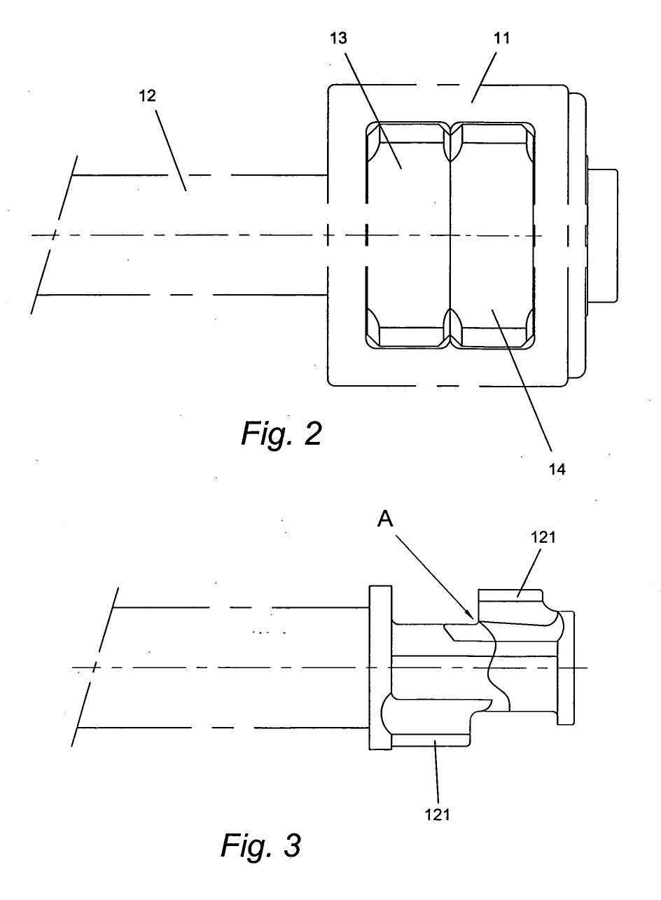

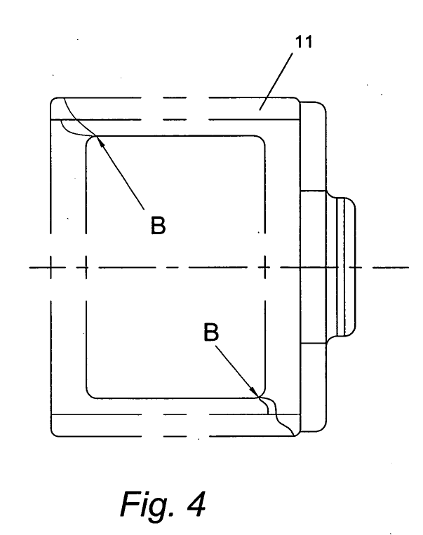

### DETAILED DESCRIPTION OF THE PREFERRED EMBODIMENTS

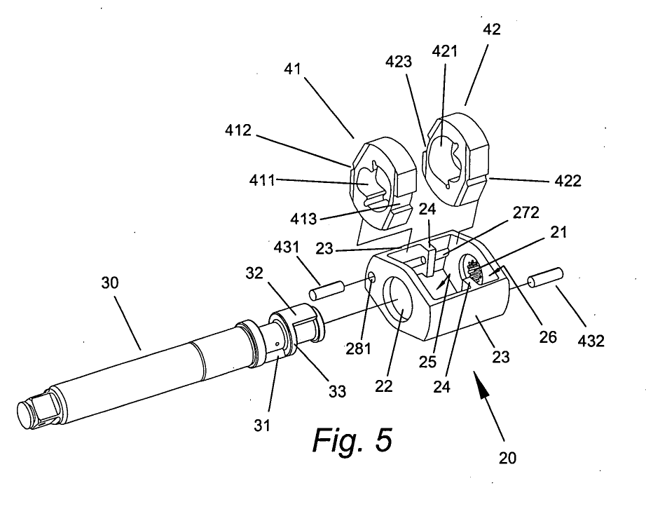

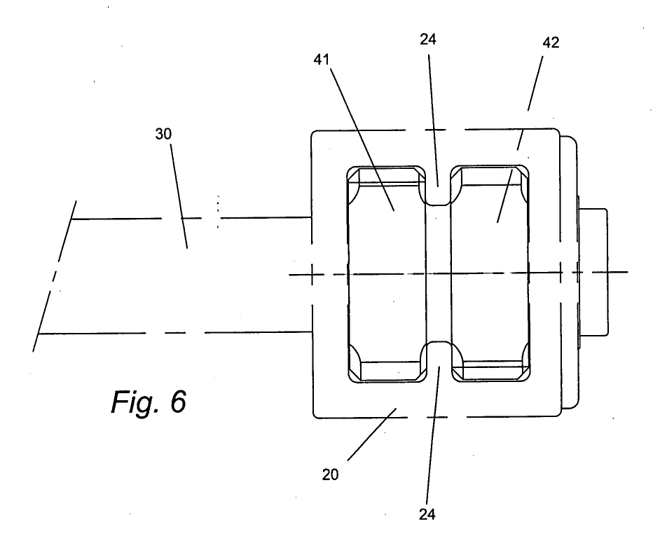

Referring to FIGS. 5 and 6, the present invention provides an improved hammering structure of a pneumatic wrench. The hammering structure essentially comprised of a hammering hold 20, a threaded hole 21 at one end of the hammering holder 20 is provided for the hammering holder 20 to link to a pneumatic motor, and a through hole 22 at the other end of the hammering holder 20 is provided for receiving insertion of a transmission shaft 30. The hammering holder 20 contains two chambers to respectively accommodate two hammers 41, 42. Both hammers 41, 42 are secured in position respectively by two locking pins 431, 432. Two hetero-holes 411, 421 are respectively provided in both hammers 41, 42 to receive insertion of two linking ribs 31, 32 of a transmission shaft 30. Wherein, both linking ribs 31, 32 are laterally and consecutively provided at the terminal of the transmission shaft 30 and both are connected to each other by a circular reinforcement rib 32 at where both linking ribs 31, 32 are interrupted.

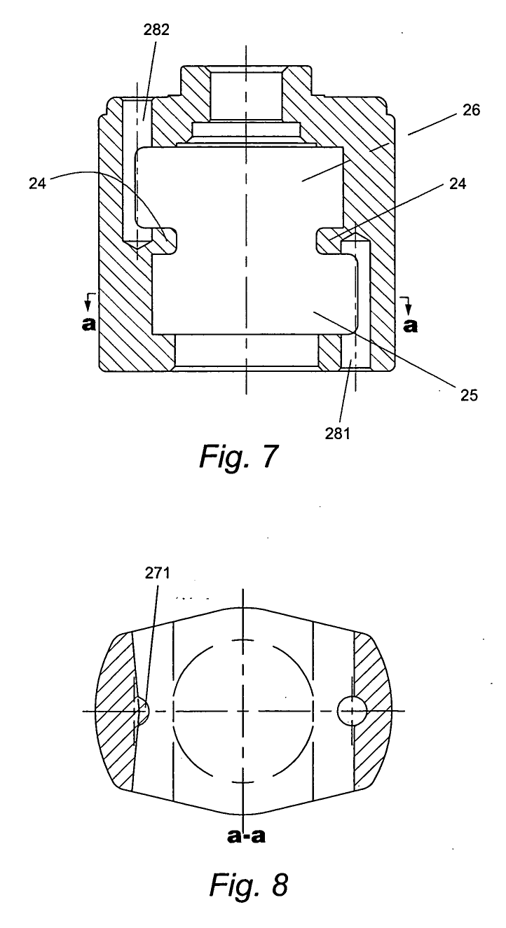

A separation rib 24 is protruding from where between two impetus walls 23 on both sides in the hammering holder 20 to divide the interior of the hammering holder 20 into a front chamber 25 and a rear chamber 26 for respectively accommodating both hammers 41, 42. As illustrated in FIGS. 7 and 8, two locking pints 431, 432 and two protruded pins 271, 272 are respectively provided to secure and link to both hammers 41, 42. Both locking pins 431, 432 are provided in relation to two arc troughs 412, 422; and both protruded ping 271, 272 are provided in relation to two wider troughs 413, 423.

Innovative and functional characteristics of the present invention are described as follows:

Over concentration of stress at the linking rib of the transmission shaft is eliminated: Referring to FIGS. 5 and 6, those two linking ribs laterally provided at the terminal of the transmission shaft 30 generate torque essentially by the impetus exercised by two hammers 41, 42; and the circular reinforcement rib 33 provided at where both linking ribs 31, 32 are interrupted connects both linking ribs 31, 32 in an integrated piece to completely eliminate the over concentrated stress otherwise happening at Point A. The stress is taken by and discharged along the circular reinforcement rib 33. Reduced stress value allows both linking ribs 31, 32 to withstand even higher torque value, provide stronger structural rigidity and longer service life.

Absence of friction due to both hammers being separated from each other: Referring to FIGS. 5, 6 and 7, the interior of the hammering holder 20 is divided by the separation rib 24 to define a front chamber 24 and a rear chamber 26 so to separate and confine both hammers 41, 42. Accordingly, both hammers work independently from each other without causing friction and wear as found with the prior art for warranting longer service life of both hammers 41, 42 and reduce their energy consumption.

Improved structural rigidity of the hammering holder: Referring to FIGS. 5 and 6, the torque of the hammering structure is conveyed from the threaded hole 21 of the hammering holder 20 upon accepting the torque from the pneumatic motor to revolve the transmission shaft 30 through both locking pins 431, 432 and both protruded pins 271, 272 of both impetus walls 23, and via both revolving hammers 41, 42. Therefore, both impetus walls 23 become part of the transmission of the moment, the separation rib 24 is used to increase the structural rigidity of each long and thin impetus walls 23, thus to reduce distort of the impetus wall 23 when subject to force applied, to absorb certain portion of the stress, and to avoid over concentration of stress at corner B. Once the stress is reduced, the structural rigidity increases in turn, the over concentration of stress is eliminated, and the service life is relatively extended.

Integrated locking ping and protruded pin to improve structural rigidity and lower production cost: Referring to FIGS. 5, 6 and 7, the length of each of both locking pins 431, 432 of the present invention is half reduced when compared to that of the prior art. Therefore, drill and shear length for both locking holes 281, 282 is relatively reduce to half, and the process cost is also relatively reduced. Whereas both protruded pins 271, 272 are integrated with the hammering holder 20, the rigidity and impact withstanding strength of the hammering structure is relatively upgraded for extended service life.

The present invention therefore offers the following advanced results:

1. Improved the rigidity of the transmission shaft. A circular reinforcement rib is provided between both linking ribs of the transmission shaft to improve the rigidity of the transmission shaft, distribute stress to eliminate over concentration of stress, upgrade the rigidity of the hammering structure and extend its service life.

2. No friction between two hammers. Both hammers are separated by the separation rib to prevent mutual friction between two hammers, and to reduce friction heat, frication consumption and loss of friction kinetics, thus to extend the service life of both hammers.

3. Improved rigidity of the hammering holder. The separation rib in the hammering holder helps improve the rigidity to upgrade the rigidity of both impetus walls, withstanding anti-torque stress, reduce stress, eliminate over concentrated stress, and relatively extend service life of the hammering holder.

4. Reduced length of the locking pin to half. Shorter locking pin relatively reduce the process cost of the locking hole; and the application of the integrated protruded pin with the hammering holder improves the structural rigidity of the hammering holder thus to relatively extend its service life.

As described, the present invention by providing improved transmission shaft and the hammering holder to upgrade the rigidity of the hammering structure for it to withstand higher stress value while eliminating over concentrated stress is innovative, advanced and practical to meet requirements of a utility patent. Therefore, this application is duly filed accordingly.

1. An improved hammering structure of a pneumatic wrench essentially comprised of a hammering holder, a threaded hole at one end of the hammering holder being provided to link to a pneumatic motor; a through hole on the other end of the hammering holder being provided to receive insertion of a transmission shaft; the hammering holder accommodating two hammers arranged laterally and secured respectively by two locking pins; and each hammer being provided with a hetero-hole to be inserted by a linking rib from the transmission shaft is characterized by that: a circular reinforcement rib being provided at where those two linking ribs consecutively provided at the terminal of the transmission shaft being interrupted; and both linking ribs being connected by the circular reinforcement rib.

2. An improved hammering structure of a pneumatic wrench as claimed in claim 1, wherein, a separation rib is protruded from where between two impetus walls on both sides in the hammering holder; the interior of the hammering holder being divided into a front chamber and a rear chamber by the separation rib; and a hammer being each accommodate by the front and the rear chambers.

3. An improved hammering structure of a pneumatic wrench as claimed in claim 1, wherein, a locking pin and a protruded pin integrated with the hammering holder are provided to each hammer to secure and link to each hammer; the locking pin being provided in relation to an arc trough on the hammer; and the protruded pin being provided in relation to a wider trough on the hammer.
